(19) United States
(12) Patent Application Publication
(10) Pub. No.: US 2016/0164162 A1
(43) Pub. Date: Jun. 9, 2016

(54) FILTER PACKAGE

(71) Applicant: Innertron, Inc., Incheon (KR)

(72) Inventors: Hak Rae CHO, Bucheon-si (KR); Soo Duk SEO, Incheon (KR); Jong Woo HA, Seoul (KR); Moon Bong KO, Incheon (KR)

(73) Assignee: Innertron, Inc., Incheon (KR)

(21) Appl. No.: 14/942,295

(22) Filed: Nov. 16, 2015

(30) Foreign Application Priority Data
Dec. 3, 2014 (KR) 10-2014-0171855

(51) Int. Cl. H01P 1/20; H01P 7/10

(52) U.S. Cl. CPC H01P 7/10; H01P 1/20

(57) ABSTRACT

A filter package includes a substrate, a plurality of resonators each coupled to the substrate, and a metal circuit pattern patterned on the substrate, and the plurality of resonators each include a body made of a dielectric material, in which a through hole is formed in one direction, and a conductive film attached to an end surface coupled to the substrate among both end surfaces of the body, and attached to a wall of the through hole.

### CROSS-REFERENCE TO RELATED APPLICATIONS

This U.S. non-provisional patent application claims priority under 35 U.S.C. §119 of Korean Patent Application No. 10-2014-0171855 filed on Dec. 3, 2014 in the Korean Patent Office, the entire contents of which are hereby incorporated by reference.

### BACKGROUND OF THE INVENTION

1. Field of the Invention

This invention relates to a filter package, and more particularly, to a filter package including a metal circuit pattern which is also patterned on a substrate to which each of a plurality of resonators is coupled through a conductive film.

2. Description of the Related Art

Various types of filters are applied to communication systems. The filters, which are devices that serve to pass only a signal in a particular frequency band, are divided into a low-pass filter (LPF), a band-pass filter (BPF), a high-pass filter (HPF), a band-stop filter (BSF), and the like according to a filtered frequency band.

Further, the filters can be divided into an inductor capacitor (LC) filter, a transmission line filter, a cavity filter, a dielectric resonator (DR) filter, a ceramic filter, a coaxial filter, a waveguide filter, a surface acoustic wave (SAW) filter, and the like according to a production method and an element used for the filter.

Recently, as demand for small-sized base stations has increased, the filters have also been required to be miniaturized.

### SUMMARY OF THE INVENTION

The present invention is directed to a filter package including a metal circuit pattern which is also patterned on a substrate to which each of a plurality of resonators is coupled through a conductive film.

A filter package according to embodiments of the present invention includes a substrate, a plurality of resonators each coupled to the substrate, and a metal circuit pattern patterned on the substrate, and the plurality of resonators each include a body made of a dielectric material, in which a through hole is formed in one direction, and a conductive film attached to an end surface coupled to the substrate among both end surfaces of the body, and attached to a wall of the through hole.

In some embodiments, the metal circuit pattern may be configured of a combination of a plurality of modules.

In other embodiments, the metal circuit pattern may include at least two of an amplifier, a high-pass filter, a band-pass filter, a low-pass filter, a coupler, a power monitor module, a voltage standing wave ratio (VSWR) monitor module, a processor, a temperature sensor, an automatic gain control (AGC) circuit, an analog-to-digital converter, and a memory.

In still other embodiments, any one of the plurality of resonators may be electrically connected to the metal circuit pattern through a coupling unit.

In yet other embodiments, the coupling unit may pass through a partition implemented between the metal circuit pattern and the plurality of resonators.

In yet other embodiments, the substrate may be a printed circuit board (PCB).

In yet other embodiments, the body may be configured of ceramic.

In yet other embodiments, the filter package may further include a housing which is coupled to the substrate and accommodates the plurality of resonators and the metal circuit pattern.

According to the embodiments of the present invention, each of a plurality of resonators is coupled to a substrate through a conductive film and a metal circuit pattern is also formed on the substrate, and thus it is possible to miniaturize an element.

Further, according to the embodiments of the present invention, the metal circuit pattern is implemented on the same substrate in a structure in which a dielectric resonator and a cavity are formed together, and thus it is possible to have the structure and performance specialized for a low-power and small-sized base station.

### BRIEF DESCRIPTION OF THE DRAWINGS

In order to more fully understand the drawings referred to in the detailed description of the present invention, a detailed description of each drawing is provided.

FIG. 1 is a plan view of a filter package according to an embodiment of the present invention.

FIG. 2 is a cross-sectional view of a filter package illustrated in FIG. 1 according to an embodiment of the present invention.

FIG. 3 is a stereoscopic view of a resonator illustrated in FIG. 1 according to an embodiment of the present invention.

### DETAILED DESCRIPTION OF THE EMBODIMENTS

As specific structural or functional descriptions for the embodiments according to the concept of the invention disclosed herein are merely exemplified for purposes of describing the embodiments according to the concept of the invention, the embodiments according to the concept of the invention may be embodied in various forms but are not limited to the embodiments described herein.

While the embodiments of the present invention are susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

It will be understood that, although the terms “first,” “second,” etc. may be used herein to describe various elements, these elements should not be limited by these terms. These terms are only used to distinguish one element from another. For example, a first element could be termed a second element, and, similarly, a second element could be termed a first element, without departing from the scope of the present invention.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

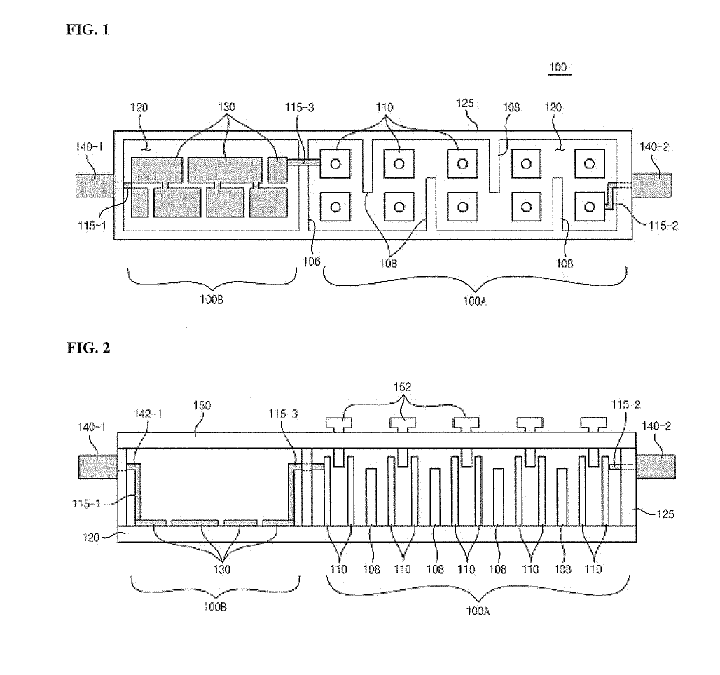

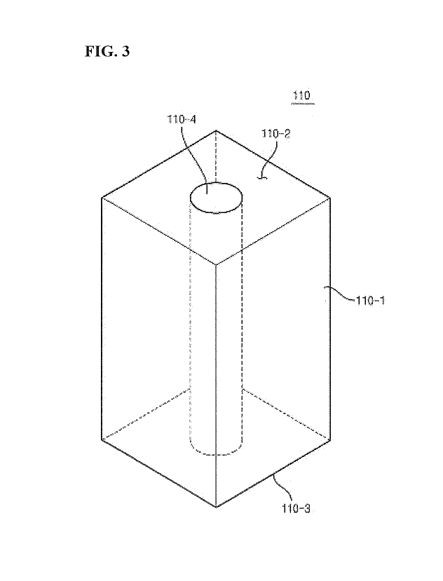

FIG. 1 is a plan view of a filter package according to an embodiment of the present invention. FIG. 2 is a cross-sectional view of a filter package illustrated in FIG. 1 according to an embodiment of the present invention.

Referring to FIGS. 1 and 2, a filter package 100 according to an embodiment of the present invention may include a plurality of resonators 110, coupling units 115-1 to 115-3, a substrate 120, a housing 125, metal circuit patterns 130, and connectors 140-1 and 140-2.

The filter package 100 may be divided into a filter part 100A and a metal circuit pattern part 100B through a separating partition 106 included in the housing 125.

The plurality of resonators 110 of the filter part 100A may be coupled onto the substrate 120 to be accommodated in the housing 125.

Structures of the plurality of respective resonators 110 may be implemented in the same manner, and the structure of each of the plurality of resonators 110 will be described with reference to FIG. 3.

The substrate 120 may be electrically connected to the plurality of resonators 110 to perform a ground function.

In some embodiments, the plurality of resonators 110 may be coupled to the substrate 120 through a conductive film. That is, the plurality of resonators 110 may be coupled to the substrate 120 through a plating process.

In other embodiments, the substrate 120 may be implemented as a printed circuit board (PCB) including a conductive pattern for performing a ground function.

Cavities divided by a plurality of partitions 108 may be included in the housing 125 and the plurality of resonators 110 may be accommodated in the cavities. The arrangement of the partitions 108 may be changed in various ways and a signal transmission and reception path within the housing 125 may be changed according to the arrangement of the partitions 108.

The housing 125 is illustrated in a rectangular parallelepiped shape, but is not limited thereto. The scope of the present invention should not be understood as limited by the shape of the housing 125.

In some embodiments, an outer surface or inner surface of the housing 125 may be plated with a conductive material (e.g., silver (Ag), copper (Cu), or the like).

The housing 125 may be coupled to the substrate 120 disposed under the housing 125 to accommodate the plurality of resonators 110.

The metal circuit patterns 130 of the metal circuit pattern part 100B may be patterned on the substrate 120 and accommodated in the housing 125.

In some embodiments, the metal circuit patterns 130 may be configured of a combination of a plurality of modules.

For example, each of the plurality of modules may be an amplifier (e.g., a low-noise amplifier (LNA)), a high-pass filter, a band-pass filter, a low-pass filter, a coupler (e.g., a directional coupler), a power monitor module, a standing wave ratio (SWR) monitor module, a processor, a temperature sensor, an automatic gain control (AGC) circuit, an analog-to-digital converter, or a memory (e.g., an electrically erasable programmable read-only memory (EEPROM)). The metal circuit patterns 130 may include at least two of the plurality of modules.

The SWR monitor module may detect a transmission and reception signal between the filter part 100A., and an antenna implemented outside the filter package 100 (not illustrated) to monitor a standing wave ratio (e.g., a voltage standing wave ratio (VSWR) or a current standing wave ratio (CSWR)).

In some embodiments, the metal circuit pattern 130 may be implemented using a microstrip line.

The connectors 140-1 and 140-2 may be implemented on both sides of the housing 125.

An input connector 140-1 may receive a radio signal from the outside of the filter package 100, and the output connector 140-2 may output a radio signal to the outside of the filter package 100.

A first coupling unit 115-1 may transmit the radio signal input through the input connector 140-1 to the metal circuit pattern 130. In some embodiments, the first coupling unit 115-1 may induce an electromagnetic wave to pass only the signal in the desired band to the metal circuit pattern 130.

A second coupling unit 115-2 may transmit a radio signal received from any one of the plurality of resonators 110 to the output connector 140-2. In some embodiments, the second coupling unit 115-2 may induce an electromagnetic wave to pass only the signal in the desired band to the output connector 140-2.

A third coupling unit 115-3 may transmit a signal received from the metal circuit pattern part 100B to the filter part 100A. That is, the third coupling unit 115-3 may perform signal coupling between the metal circuit pattern part 100B and the filter part 100A.

In some embodiments, any one of the plurality of resonators 110 and the metal circuit pattern 130 may be electrically connected through the third coupling unit 115-3.

In other embodiments, the third coupling unit 115-3 may pass through the separating partition 106 formed between the metal circuit pattern part 100B and the filter part 100A.

In still other embodiments, the third coupling unit 115-3 may be implemented in a coupling loop form.

Although not illustrated in FIG. 1, referring to FIG. 2, a cover 150 formed on the housing 125 may be further included. The cover 150 may be coupled to an upper portion of the housing 125 to cover an open side of the housing 125.

In some embodiments, the cover 150 may be implemented with a conductive material.

The filter package 100 may further include tuning screws 152 coupled to the cover 150. The tuning screw 152 may be moved upward and downward to adjust a resonance frequency.

In some embodiments, the tuning screw 152 may be implemented in a spiral screw shape and moved upward and downward in the form of a screw.

FIG. 3 is a stereoscopic view of the resonator illustrated in FIG. 1 according to an embodiment of the present invention.

Referring to FIGS. 1 and 3, each resonator 110 may include a body 110-1 made of a dielectric material (e.g., ceramic or the like).

In some embodiments, the body 110-1 may be implemented in various shapes such as a cylindrical shape, an elliptic cylindrical shape, and the like in addition to a square pillar shape.

A through hole 110-4 may be formed in one direction of the body 110-1. For example, the through hole 110-4 may be formed in a longitudinal direction of the body 110-1, that is, in a longest side direction of the body 110-1.

In some embodiments, at least one end surface of both end surfaces 110-2 and 110-3 in the longitudinal direction of the body 110-1 may be plated with a conductive film.

In other embodiments, an inner surface of the through hole 110-4 may be plated with a conductive film (e.g., a conductive film by plating with silver or copper).

A lower end surface 110-3 of the body 110-1 may be coupled to the substrate 120 through the plating process, that is, may be grounded.

The plating process may not be performed on other surfaces other than both of the end surfaces 110-2 and 110-3 in the longitudinal direction of the body 110-1.

According to such a structure, each of the resonators 110 may operate in a transverse electromagnetic (TEM) mode.

While the invention has been described with reference to exemplary embodiments illustrated in accompanying drawings, these should be considered in a descriptive sense only, and it will be understood by those skilled in the art that various alternations and equivalent other embodiment may be made. Therefore, the scope of the invention is defined by the appended claims.

What is claimed is:

1. A filter package, comprising:
a substrate;
a plurality of resonators each coupled to the substrate; and
a metal circuit pattern patterned on the substrate,
wherein the plurality of resonators each include:
a body made of a dielectric material, in which a through hole is formed in one direction; and
a conductive film attached to an end surface coupled to the substrate among both end surfaces of the body, and attached to a wall of the through hole.

2. The filter package of claim 1, wherein the metal circuit pattern is configured of a combination of a plurality of modules.

3. The filter package of claim 2, wherein the metal circuit pattern includes at least two of an amplifier, a high-pass filter, a band-pass filter, a low-pass filter, a coupler, a power monitor module, a voltage standing wave ratio (VSWR) monitor module, a processor, a temperature sensor, an automatic gain control (AGC) circuit, an analog-to-digital converter, and a memory.

4. The filter package of claim 1, wherein any one of the plurality of resonators is electrically connected to the metal circuit pattern through a coupling unit.

5. The filter package of claim 4, wherein the coupling unit passes through a partition implemented between the metal circuit pattern and the plurality of resonators.

6. The filter package of claim 1, wherein the substrate is a printed circuit board (PCB).

7. The filter package of claim 1, wherein the body is configured of ceramic.

8. The filter package of claim 1, further comprising a housing coupled to the substrate and configured to accommodate the plurality of resonators and the metal circuit pattern.
